(19) United States
(12) Patent Application Publication
(10) Pub. No.: US 2014/0161958 A1
(43) Pub. Date: Jun. 12, 2014

(54) MEAT SUBSTITUTE PRODUCT

(71) Applicant: CARGILL, INCORPORATED, Wayzata, MN (US)

(72) Inventors: Ann Waylan BRACKENRIDGE, London (CA); Thomas Richard KATEN, Willshire, OH (US); Joseph L. KLEMASZEWSKI, Plymouth, MN (US); Donald Andrew MOSS, Elk River, MN (US)

(73) Assignee: CARGILL, INCORPORATED, Wayzata, MN (US)

(21) Appl. No.: 14/177,709

(22) Filed: Feb. 11, 2014

Related U.S. Application Data
(62) Division of application No. 13/989,369, filed on May 23, 2013, now abandoned.
(60) Provisional application No. 61/418,686, filed on Dec. 1, 2010.

(51) Int. Cl. A23D 7/005; A23L 1/48

(52) U.S. Cl. CPC A23D 7/0053; A23L 1/483
USPC 426/602

(57) ABSTRACT

A meat substitute product is disclosed. A meal substitute, such as vegetable protein, is blended with a starch, hydrocolloid, and an oil from a vegetable source.

### FIELD

The present disclosure relates generally to a meat substitute product. Aspects of the disclosure are particularly directed to a meat substitute product consisting of a meat substitute, starch(es), hydrocolloid(s), and oil(s) from a vegetable source(s).

### BACKGROUND

Many people are choosing to limit the amount of meat in their diet. Specifically, people are looking to reduce the amount of animal fat in their diets. Animal fat is a primary source of saturated fat, which raises blood cholesterol.

Despite the desire to limit meat in the diet, people nonetheless want to eat products that were traditionally meat-based products, such as burgers. Non-meat burgers can he made, for example, from vegetables, legumes, nut, dairy products, mushrooms, grain or textured vegetable protein.

Fat in a non-meat burger, and other meat substitutes, plays a vital role in a variety of sensory attributes, including juiciness, mouth feel and flavor. When a meat substitute product has lower amounts of fat, there is a tendency for the cooked product to be less desirable in regards to juiciness, mouth feel and flavor. On the contrary, when a meat substitute product has an optimal amount of fat, it is more desirable in terms of juiciness, mouth feel and flavor.

Meat substitute products also are an appropriate system for the application of functional fats. A functional food ingredient is defined as an ingredient or food that provides potential health benefits beyond basic nutrition. These functional components can be naturally occurring or may he added to certain foods. Such ingredients include but arc not limited to Omega-3 fatty acids, antioxidants, phytosterols and dietary fibers. The functional fat system would serve as a delivery medium to deliver functional ingredients into processed meat products.

### SUMMARY

This invention allows for the production of a meat substitute product without sacrificing sensory attributes. There is a nutritional/sensory interaction which allows for the addition of a modifying agent to textured soy protein meat substitute which increases the sensory attributes of the product.

One embodiment of this invention is directed toward a meat substitute composition comprising a meat substitute, a starch, a gum and an oil from a non-animal source.

### DETAILED DESCRIPTION

The present invention will now be described in more detail.

The meat composition of the present invention comprises (A) meat substitute, (B) starch(es), (C) hydrocolloid(s), and (D) oil(s) from a vegetable source(s).

Component A: Meat Substitute. The meat substitute composition can be vegetables, legumes, nuts, dairy products, eggs, mushrooms, grains or vegetable protein.

Component B: Starch. Starch is a carbohydrate polymer. Starches are comprised of amylose and amylopectin and arc typically in the form of granules. Amylopectin is the major component (about 70-80%) of most starches. It is found in the outer portion of starch granules and is a branched polymer of several thousand to several hundred thousand glucose units. Amylose is the minor component (about 20-30%) of most starches (there are high amylose starches with 50 to 70% amylose). It is found in the inner portion of starch granules and is a linear glucose polymer of several hundred to several thousand glucose units.

Sources of starch include but are not limited to fruits, seeds, and rhizomes or tubers of plants. Common sources of starch include but are not limited to rice, wheat, corn, potatoes, tapioca, arrowroot, buckwheat, banana, barley, cassava, kudzu, oca, sago, sorghum, sweet potatoes, taro and yams. Edible beans, such as favas, lentils and peas, are also rich in starch.

Some starches are classified as waxy starches. A waxy starch contains high amounts of amylopectin with very little amylose. Common waxy starches include waxy maize starch, waxy rice starch, and waxy wheat starch.

A modified starch is one that has been altered from its native state, resulting in modification of one or more of its chemical or physical properties. Starches may be modified, for example, by enzymes, oxidation or, substitution with various compounds. Starches can be modified to increase stability against heat, acids, or freezing, improved texture, increase or decrease viscosity, increase or decrease gelatinization times, and increase or decrease solubility, among others. Modified starches may be partially or completely degraded into shorter chains or glucose molecules. Amylopectin may be debranched. Starches that are modified by substitution have a different chemical composition. A nOSA starch is a modified starch that has been partially substituted with n-octenyl succinic anhydride.

Component C: Hydrocolloid. Hydrocolloids are a family of long chain water soluble polysaccharides and are generally carbohydrate based which affect the viscosity/gelling of aqueous solutions. Common examples are locust bean gum, carrageenan (seaweed extract), guar gum, xanthan gum, gellan gum, scleroglucan, agar, pectin, alginate, cellulose derivatives, and gum acacia. These are broadly classified as gums. Starches and gelatin are sometimes characterized as hydrocolloids. One skilled in the art can use combinations of starches, gelatin, and gums to achieve desired texture and melt properties.

Component D: Oil from vegetable source(s): A lipid material composed of a mixture of generally triacylglycerides from non-animal sources such as soya, olive, rapeseed, avocado, palm, palm kernel, coconut, cocoa, peanut, corn, flax, sunflower, safflower, and cottonseed. These lipids may be solid or liquid at room temperature depending on the chain lengths of the fatty acids, degree of saturation, and method of hydrogenation. Oils from multiple sources may he combined or certain fractions removed by processing such as winterization.

One significant benefit of this invention is to replace the animal oils with oils that have a dietary functional use.

### Examples

Various products have been manufactured. Each comprises a fat mimetic and a meat substitute. The examples below are merely illustrative and not limiting.

### Vegan Fat Mimetic

| Ingredient | Percentage |
|---|---|
| Water | 40-60% |
| Vegetable Shortening | 15-35% |
| Acid Thinned Starch | 7-15% |
| Acid thinned nOSA starch, (EmCap ™ 06375) | 5-12% |
| Viscosifying nOSA starch, (DeliTex ™ 75320) | 3-8% |
| Kappa Carrageenan, (Satiagel ™ ME4) | 1-3% |
| Salt | 0-4% |
| Guar gum/xanthan gum | 0-3% |

All ingredients are compiled and then heated with agitation to 165 to 170° F. using a Blentech model CC-10 at low speed. Direct steam injection is quickest method, but other methods are possible. Product is hot filled and cooled. After refrigeration for a minimum of 24 hours the product can be ground, diced, grated, or shredded to desired size.

### Veggy Burger

| Ingredient | Percentage |
|---|---|
| Water | 45.6% |
| Textured soy flour | 20.0% |
| Vegan fat mimetic | 20.0% |
| Flavors, seasonings, salt, and colors | 5.4% |
| Soy Flour | 3.0% |
| Methylcellulose | 2.0% |
| Autolyzed yeast extract | 2.0% |
| Modified wheat gluten | 2.0% |

Add dry textured soy flour to mixer with ⅔ water and mix for five minutes. Add wheat gluten, fat mimetic, soy flour and methylcellulose to mixer and start mixing. Add remaining ⅓ water and mix for ten minutes until tacky. Add remaining dry ingredients and mix for five to ten minutes. Form patties and cook to internal of 165° F.

1.-18. (canceled)

19. A method of preparing a meat substitute product, the method comprising:
a. preparing a mixture consisting essentially of:
i. 40% to 60% water;
ii. 15% to 35% of a vegetable lipid material;
iii. 15% to 35% of at least one starch; and
iv. 1% to 6% of a hydrocolloid;
b. heating the mixture to 165° F. to 170° F.;
c. cooling the heated mixture to provide a fat mimetic; and
d. combining a meat substitute and the fat mimetic to provide a meat substitute product.

20. The method of claim 19, wherein the vegetable lipid material the is selected from the group consisting of soya oil, olive oil, canola oil, avocado oil, palm oil, palm kernel oil, coconut oil, cocoa oil, peanut oil, corn oil, flax oil, sunflower oil, safflower oil, cottonseed oil, and combinations thereof.

21. The method of claim 19, wherein the vegetable lipid material comprises a vegetable shortening.

22. The method of claim 19, wherein the starch is selected from the group consisting of modified corn starches, modified tapioca starches, modified potato starches, modified rice starches, modified wheat starches, modified sago starches, and combinations thereof.

23. The method of claim 19, wherein the starch comprises an nOSA starch.

24. The method of claim 19, wherein the hydrocolloid is selected from the group consisting of a locust bean gum, a carrageenan (seaweed extract), a guar gum, a xanthan gum, a gellan gum, a scleroglucan, an agar, a pectin, an alginate, a cellulose derivative, a gum acacia, a gelatin, and combinations thereof.

25. The method of claim 19, wherein the hydrocolloid comprises a carrageenan.

26. The method of claim 25, wherein the carrageenan is a kappa carrageenan.

27. The method of claim 19, further comprising a second hydrocolloid different from the first hydrocolloid, the second hydrocolloid selected from the group consisting of a locust bean gum, a carrageenan (seaweed extract), a guar gum, a xanthan gum, a gellan gum, a scleroglucan, an agar, a pectin, an alginate, a cellulose derivative, a gum acacia, a gelatin, and combinations thereof.

28. The method of claim 27, wherein the second hydrocolloid comprises at least one of a guar gum and a xanthan gum.

29. The method of claim 27, wherein the mixture comprises 3% or less of the second hydrocolloid.

30. The method of claim 19, wherein heating comprises direct steam injection.

31. The method of claim 19, wherein cooling occurs for at least 24 hours.

32. The method of claim 19, wherein the meat substitute is selected from the group consisting of vegetables, legumes, nuts, dairy products, eggs, mushrooms, grains and vegetable proteins, and combinations thereof.

33. The method of claim 32, wherein the meat substitute comprises a soy flour.

34. The method of claim 19, wherein the meat substitute product further comprises at least one of a flavor, a seasoning, a salt, and a color.

35. The method of claim 19, wherein the meat substitute product further comprises a methylcellulose.

36. The method of claim 19, wherein the meat substitute product further comprises a yeast extract.

37. The method of claim 19, wherein the amount of meat substitute in the meat substitute product is not less than 5% by weight.

38. The method of claim 19, wherein the amount of meat substitute in the meat substitute product is not less than 10% by weight.
